(19) United States
(12) Patent Application Publication
(10) Pub. No.: US 2022/0233970 A1
(43) Pub. Date: Jul. 28, 2022

(54) COLUMN FOR EXCHANGING HEAT AND/OR MASS

(71) Applicant: L'Air Liquide, Société Anonyme pour I'Etude et I'Exploitation des Procédés Georges Claude, Paris (FR)

(72) Inventors: Ludovic AMANT, Vaires sur Marne (FR); Camille MARIE, Paris (FR); Eric MASLIAH, Brunoy (FR); Patrick LE BOT, Vincennes (FR)

(21) Appl. No.: 17/611,475

(22) PCT Filed: May 12, 2020
(86) PCT No.: PCT/EP2020/063222

§ 371 Date: Nov. 15, 2021

(30) Foreign Application Priority Data
May 16, 2019 (FR) FR1905124

(51) Int. Cl. B01D 3/32; B01D 3/00

(52) U.S. Cl. CPC B01D 3/32; B01D 3/008

(57) ABSTRACT

The invention relates to a retaining device for retaining a heat and/or mass exchange means intended for a heat and/or mass exchange column and having at least one flexible strip in which there are formed at least two cutouts, the strip extending predominantly in a main direction of extension between two longitudinal ends. The cutouts are configured to adjust a dimension of elongation of the strip, in the main direction of extension, to suit a dimension of the heat and/or mass exchange column.

### CROSS REFERENCE TO RELATED APPLICATIONS

This application is a 371 of International Application No. PCT/EP2020/06322, filed May 12, 2020, which claims priority to French Patent Application No. 1905124, filed May 16, 2019, the entire contents of which are incorporated herein by reference.

### BACKGROUND

The field of the present invention is that of columns for exchanging heat and/or mass and, more particularly, devices for retaining heat exchange means and/or mass exchange means arranged in such columns.

Heat and/or mass exchange columns are today used in a wide variety of processes. For example, heat and/or mass exchange columns allow scrubbing processes, cooling processes, heating processes or distillation processes to be implemented. All of these processes are based on a single basic principle, namely the exchange of heat and/or of mass between two fluids. These two fluids may, for example, be two liquids, two gases, or else a liquid and gas.

Such columns thus comprise at least one heat and/or mass exchange means through which the two fluids pass and in which the exchange of heat and/or of mass between these two fluids take place. Conventionally, these heat and/or mass exchange means rest on a support element which may be secured directly inside the heat and/or mass exchange column concerned, or more particularly on a peripheral wall of this heat and/or mass exchange column, or which may rest against a structural element, itself secured to the peripheral wall of the heat and/or mass exchange column.

One disadvantage with the current support elements notably lies in the fact that their retention in the heat and/or mass exchange column is governed by a step of fixing, for example brazing or welding, this support element, or the structural element against which it rests, into the heat and/or mass exchange column.

### SUMMARY

The present invention falls within this context and seeks to alleviate at least this disadvantage by proposing a device for retaining a heat and/or mass exchange means that is simple and inexpensive in terms of manufacture, configured to support this heat and/or mass exchange means without having to be secured to the heat and/or mass exchange column.

One subject of the present invention thus relates to a heat and/or mass exchange column comprising at least one peripheral wall delimiting an internal volume in which there are arranged at least one heat exchange means and at least one retaining device for retaining the heat and/or mass exchange means, the device comprising at least two flexible strips in which there are formed at least two cutouts, the strips extending predominantly in a main direction of extension between two longitudinal ends. According to the invention, the cutouts are configured to adjust a dimension of elongation of the strips, in said main direction of extension, to suit a dimension of the heat and/or mass exchange column. In other words, the cutouts made in the strips give these strips an elasticity which, on the one hand, allows the strip to be introduced into the heat and/or mass exchange column for which it is intended and, on the other hand, ensures that these strips are retained in this heat and/or mass exchange column once they have been positioned therein.

In addition, at least the longitudinal ends of the at least one strip bear against the peripheral wall.

According to one feature of the present invention, the two longitudinal ends are joined together by two transverse edges and the cutouts are respectively formed closer to one of the longitudinal ends of the strip than to a center of this strip, What is meant by “center of the strip” is a point on this strip that is equidistant from the two longitudinal ends of this strip and also equidistant from the two transverse edges of this strip. Advantageously, provision may be made for a cutout to be formed near each longitudinal end of the strip, namely one cutout is then formed nearer to one of the longitudinal ends of the strip than to the center of this strip, and the other cutout is formed nearer to the other longitudinal end than to the center of the strip.

According to one particular embodiment of the present invention, the two transverse edges of the strip are parallel to one another, which is to say that, according to this particular embodiment, the strip has a substantially rectangular shape.

According to one feature of the present invention, each cutout extends from one of the transverse edges of the strip. Advantageously, the strip comprises at least four cutouts distributed in pairs, each pair of cutouts being formed closer to a longitudinal end of the strip than to the center of this strip. For example, the two cutouts of one pair of cutouts extend respectively from opposite transverse edges of the strip. In other words, according to this example, the two cutouts of each pair of cutouts are formed top to tail. It will be appreciated that the greater the number of cutouts formed in the strip, the greater will be the elasticity of this strip.

According to one feature of the present invention, at least one longitudinal end of the strip has at least one chamfer. Advantageously_{;} at least one longitudinal end of the strip has two chamfers joined together by a ridge. More advantageously still, the two longitudinal ends of the strip each have two chamfers joined together by a ridge. These chamfers are notably configured to facilitate insertion of the retaining device according to the invention into the heat and/or mass exchange column for which it is intended.

According to one embodiment of the present invention, the retaining device comprises at least two strips. For example, these two strips may intersect. According to one embodiment of the present invention, these strips intersect substantially at their center, which is to say at a point equidistant from the two longitudinal ends of the strip concerned. Thus, according to this embodiment, these strips may for example be arranged in an X or in a cross.

According to another embodiment of the present invention, the retaining device comprises at least four strips which form a lattice. Advantageously, these strips may be parallel in pairs. Even more advantageously still, provision may be made for at least two strips to extend predominantly in a first direction, and for at least two strips to extend predominantly in a second direction, the first direction being perpendicular to the second direction. What is meant by “at least two strips extend predominantly in a first direction” and “at least two strips extend predominantly in a second direction” is that the two strips concerned extend in two directions which are parallel to the first direction or to the second direction. Advantageously, these strips may thus form a square grid pattern, which is to say that the strips delimit rectangular or else square openings.

It must be understood that the size of the retaining device may be adapted by altering the number of strips and/or at least one dimension of a strip. The dimensions of this retaining device can thus be increased or decreased by adding strips in one direction or in the other, that is to say by adding strips that extend predominantly in the first direction or in the second direction. Advantageously, the retaining device according to the present invention is thus easily adaptable to suit all types of heat and/or mass exchange columns.

According to one feature of the present invention, at least one strip comprises at least one slot configured to accept another strip. In other words, it will be appreciated that these strips fit into one another. For example, the at least one slot may have a dimension equivalent, or substantially equivalent, to a transverse dimension of the strip that it accepts, namely a dimension measured parallel to a straight line perpendicular to the main extension direction of the strip concerned. Advantageously, each strip may comprise at least two slots, each slot being configured to accept another strip. Even more advantageously still, each strip may comprise more than two slots, each of these slots being intended to accept a strip.

The retaining device according to the invention is intended to be incorporated into a heat and/or mass exchange column, itself intended for a heat and/or mass exchange apparatus which comprises the heat and/or mass exchange column or several heat and/or mass exchange columns possibly assembled with one another.

According to the invention, the strips of the retaining device may comprise a mass of which the melting point is higher than the maximum operating and/or manufacturing temperature of such a heat and/or mass exchange column, for example mass of which the melting point is higher than 500° C.

Advantageously, that makes it possible to avoid any deformation or deterioration of the retaining device according to the invention during the course of operating and/or manufacturing these heat and/or mass exchange columns. For example, the strips may be made of stainless steel.

Advantageously, only the longitudinal ends of the strips of this retaining device bear against the peripheral wall of the column. It will further be appreciated that, in order to be able to bear against the peripheral wall of the heat and/or mass exchange column, each of the strips of the retaining device according to the invention has a longitudinal dimension, which is to say a dimension measured between its two longitudinal ends, parallel to the main extension direction of the strip concerned, that is greater than a cross section of the column, namely a dimension of this column that is measured between two opposite points on the peripheral wall thereof. As these strips are also flexible, inserting them into the column causes elastic deformation of these strips, and once in position in the column, they tend to revert to their original shape. As a result, the longitudinal ends of each strip apply force to the peripheral wall of the heat and/or mass exchange column, thus maintaining the position of the retaining device in the heat and/or mass exchange column. In other words, the mechanical securing of the retaining device according to the invention in the heat and/or mass exchange column requires no additional fixing means.

According to one feature of the present invention, at least two strips of the retaining device have a transverse edge that can be inscribed in a plane against which the heat and/or mass exchange means rests. In other words, this plane forms a bearing surface intended to accept at least the heat exchange means. Advantageously, at least one transverse edge of each strip can be inscribed in this plane. In other words, the heat and/or mass exchange means therefore rests on at least one transverse edge of each strip.

It will be appreciated from the foregoing that, when the retaining device is arranged in the heat and/or mass exchange column for which it is intended, the cutouts formed in the strips are arranged as dose as possible to the peripheral wall of this heat and/or mass exchange column. These cutouts contribute to the elasticity of the strips and, therefore, also contribute to generating the forces mentioned hereinabove which maintain the position of the retaining device according to the invention in the heat and/or mass exchange column for which it is intended.

According to one feature of the present invention, the heat and/or mass exchange column extends predominantly along a main extension axis, the heat and/or mass exchange column comprising at least two retaining devices arranged one on each side of the at least one heat and/or mass exchange means along the main extension axis. Advantageously, that allows the heat and/or mass exchange means to be retained in the heat and/or mass exchange column regardless of the position in which this column is situated. In other words, that ensures the position of the heat and/or mass exchange means along the main extension axis of the heat and/or mass exchange column in which it is arranged. For example, this heat and/or mass exchange column is thus easier to transport.

Optionally, at least one mesh structure may be arranged between the heat and/or mass exchange means and at least one retaining device according to the invention. Advantageously, such a mesh structure prevents the heat and/or mass exchange means that is resting on the retaining device according to the invention from passing through the latter. In other words, this mesh structure then rests against the bearing surface formed by the plane in which a transverse edge of at least two strips of the retaining device according to the invention can be inscribed. Such a mesh structure will thus be fitted when the heat and/or mass exchange means comprises one or more elements the dimensions of which are smaller than the spacing between two strips. For the same reasons as those mentioned hereinabove, this mesh structure may advantageously be made from a mass of which the melting point is higher than 500° C. According to one embodiment of the present invention, the mesh structure is made from the same mass as the retaining device according to the invention.

It will be appreciated that if the column comprises two retaining devices according to the present invention, then provision may be made for at least one mesh structure to be arranged between each retaining device and the heat and/or mass exchange means around which they are distributed. In other words, the heat and/or mass exchange means is then in contact with two mesh structures, themselves respectively arranged in contact with a retaining device according to the invention.

According to the invention, the at least one heat and/or mass exchange means comprises beads and/or plates extending predominantly in a direction parallel to the main extension axis of the column and/or structured packings and/or random packings,

The present invention also relates to a heat and/or mass exchange apparatus comprising at least one heat and/or mass exchange column according to the invention, According to the invention, the heat and/or mass exchange apparatus may comprise at least one liquid inlet and at least one gas inlet which are distributed on either side of the heat and/or mass exchange means arranged in the column, along the main extension axis of this heat and/or mass exchange column.

According to one feature of the present invention, the heat and/or mass exchange apparatus also comprises at least one liquid outlet and at least one gas outlet which are distributed on either side of the heat and/or mass exchange means arranged in the column, along the main extension axis of this heat and/or mass exchange column. Advantageously, the gas outlet and the liquid inlet are both at one end of the heat and/or mass exchange column, while the liquid outlet and the gas inlet are arranged at the other end of the heat and/or mass exchange column.

The present invention relates finally to a heat and/or mass exchange process using a heat and/or mass exchange apparatus according to the invention, wherein the process is a scrubbing and/or cooling and/or heating and/or distillation and/or treatment process. According to one particular embodiment of the present invention, the process may be a cryogenic distillation process.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 is a partial view, in vertical section, of a heat and/or mass exchange column according to the invention, this FIG. 1 showing a heat and/or mass exchange means and a retaining device for retaining this heat and/or mass exchange means according to the invention;

FIG. 2 is a partial view, in vertical section, of the heat and/or mass exchange column according to the invention, this FIG. 2 illustrating a heat and/or mass exchange column in which there are arranged a heat and/or mass exchange means and two retaining devices for retaining this heat and/or mass exchange means according to the invention;

FIG. 3 is a perspective illustration of a first embodiment of the retaining device for retaining the heat and/or mass exchange means according to the present invention;

FIG. 4 is a perspective illustration of a second embodiment of the retaining device for retaining the heat and/or mass exchange means according to the present invention.

### DETAILED DESCRIPTION OF PREFERRED EMBODIMENTS

In the remainder of the description, the terms “heat and/or mass exchange means” and “exchange means” will be used without distinction. Similarly, the terms “heat and/or mass exchange column” and “column” will be used without distinction, as will the terms “heat and/or mass exchange apparatus” and “apparatus”. A vertical direction corresponds to a main direction of extension of a heat and/or mass exchange apparatus according to the invention, when this apparatus is in a functional position, i.e. a position in which a heat and/or mass exchange can take place.

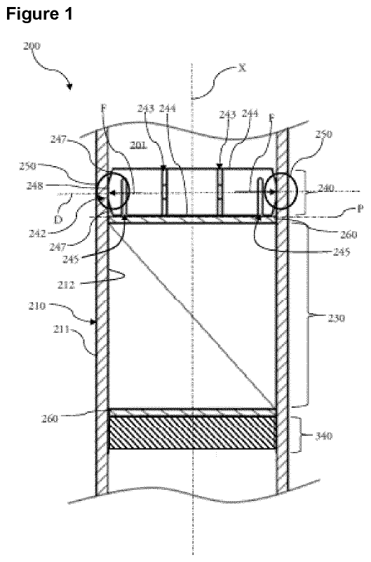

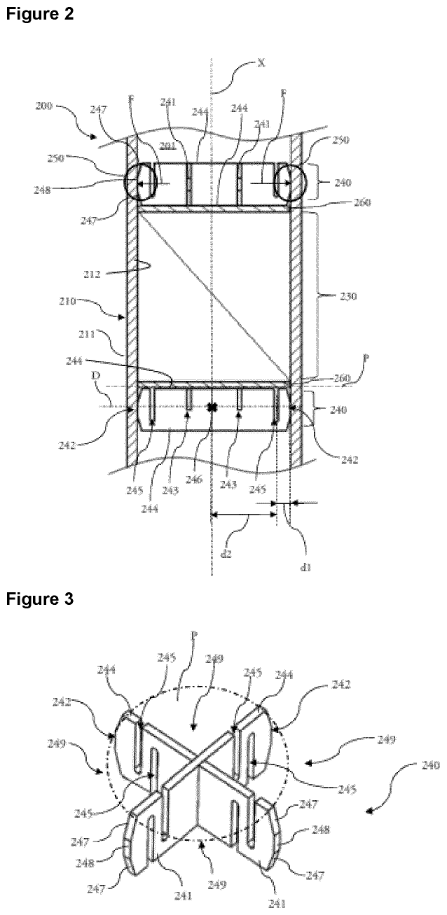

FIGS. 1 and 2 each illustrate, partially and in vertical section, a heat and/or mass exchange column 200 according to the invention, these FIGS. 1 and 2 notably showing a heat and/or mass exchange means 230 and at least one retaining device 240 for retaining this heat and/or mass exchange means 230 according to the invention. What is meant by “vertical section” is a section made on a plane in which a main extension axis X of the column 200 can be inscribed.

Such a heat and/or mass exchange column 200 may be used for heating and/or for cooling and/or distillation and/or for stripping and/or for scrubbing and/or for treatment. It may for example be a cryogenic distillation column, for example intended for the cryogenic distillation of air.

This heat and/or mass exchange column 200 extends predominantly along a main extension axis X and is intended to be assembled with other heat and/or mass exchange columns to form a heat and/or mass exchange apparatus not illustrated here. Such a heat and/or mass exchange apparatus may be configured to allow an exchange of heat and/or of mass between two fluids. For example, the apparatus can thus be configured to allow an exchange of heat and/or of mass between a liquid that circulates in the apparatus in a first direction and a gas that circulates in the apparatus in a second direction, It is understood that any other process for the exchange of heat and/or mass between two fluids can be implemented by the apparatus according to the invention without departing from the context thereof. For example, the apparatus can be configured to implement a scrubbing process and/or a cooling process and/or a heating process and/or a distillation process and/or a treatment process. In any case, the apparatus according to the invention comprises at least one inlet for the first fluid, for example a liquid inlet, and at least one inlet for the second fluid, for example a gas inlet, these fluid inlets not being depicted in the figures described here. Likewise, the apparatus may comprise at least one outlet for a third fluid and/or at least one outlet for a fourth fluid.

As illustrated in FIGS. 1 and 2, the column 200 comprises at least one peripheral wall 210 that delimits an internal volume 201 of the column 200. More specifically, the peripheral wall 210 comprises at least one external face 211 and an internal face 212, the internal face 212 more particularly delimiting this internal volume 201. At least one heat and/or mass exchange means 230 is arranged in this internal volume 201. Advantageously, a plurality of heat and/or mass exchange means 230 are arranged in the one same column 200, each of these heat and/or mass exchange means 230 being housed in a compartment of the column 200, this compartment being delimited, at least in part, by at least one distribution device. This distribution device—not illustrated here—is notably configured to ensure an even distribution of at least the first fluid, advantageously of the first fluid and the second fluid, over the one or more heat and/or mass exchange means. It is understood that this even distribution makes it possible to encourage the heat and/or mass exchanges that take place in these exchange means. Each compartment of the column 200 further comprises at least one retaining device 240 for retaining the heat and/or mass exchange means according to the invention, which is to say that this retaining device 240 forms a support, or contributes to forming a support, against which the heat and/or mass exchange means comes to bear.

According to the invention, the retaining device 240 according to the invention may be used to retain a heat and/or mass exchange means 230 inside any type of heat and/or mass exchange column 200. The column 200 may thus, for example. be cylindrical, prismatic, or parallelepipedal. The heat and/or mass exchange means 230 may itself be formed of random packings, structured packings, for example of the cross-corrugated type, or else of beads.

Advantageously, the elements arranged in this column 200 are not fixed thereto, but it is possible for them to be so.

An example of a heat and/or mass exchange means 230 and the retaining device 240 against which it is arranged, will now be described in greater detail. FIG. 1 illustrates one embodiment of the present invention, in which the heat and/or mass exchange column 200 comprises a retaining device 240 for retaining the heat and/or mass exchange means according to the invention, and FIG. 2 for its part illustrates another embodiment of the present invention, in which the heat and/or mass exchange column 200 comprises two retaining devices 240 according to the invention. These FIGS. 1 and 2 more particularly illustrate a vertical section through one of the compartments of the column 200.

FIGS. 1 and 2 show, amongst other things, the external face 211 of the peripheral wall 210 of the column 200, by virtue of which face the column is secured to other columns 200, and the internal face 212 of this peripheral wall 210 which delimits, at least in part, the internal volume 201 of the column 200. As previously mentioned, at least one heat and/or mass exchange means 230 and at least one retaining device 240 for retaining this heat and/or mass exchange means 230 are arranged inside this internal volume 201. This at least one retaining means 240 is configured to position the exchange means 230 in the column 200 and notably to position it along the main extension axis X of the column 200. Thus, as for example illustrated in FIG. 1, this at least one retaining device 240 needs to be arranged above the exchange means 230 when the apparatus to which the column 200 concerned belongs is in its functional position. According to the example illustrated in this FIG. 1, a support element 340 for supporting the heat and/or mass exchange means 230 is also arranged under this exchange means 230.

This support element 340 may be selected from among all the currently known support elements 340 and here differs from the retaining device 240 according to the invention at least in that it needs to be fixed to the peripheral wall 210 of the column 200 in order for its position to be ensured. For example, this support element 340 may be welded or brazed to the peripheral wall 210 of the column 200. Alternatively, this support element 340 may be formed as one with the internal face 211 of this peripheral wall 210 of the column 200. The retaining device 240 according to the invention is described hereinbelow, with reference to FIG. 2, the references that refer to the same objects being identical across all the figures.

According to one particular application of the present invention, an air gas ascending in the column 200 may be distilled, for example in the exchange means 230, to produce a nitrogen-enriched gas above the exchange means and an oxygen-enriched liquid below the exchange means. Liquid, from an external liquid inlet or from another exchange means arranged above the exchange means 230 illustrated falls down into the latter where an exchange of heat and/or of mass takes place with the air gas coming, for example, from an exchange means arranged below the exchange means 230 illustrated. The air gas may be air or nitrogen-enriched air if it comes from the exchange means arranged below the exchange means 230 illustrated.

FIG. 2 illustrates another embodiment of the present invention in which the column 200 comprises two retaining devices 240 according to the invention. As illustrated, these two retaining devices 240 for retaining the heat and/or mass exchange means 230 are arranged one on each side of this exchange means 230 along the main extension axis X of the column 200. Advantageously, the use of two retaining devices 240 ensures the positioning of the heat and/or mass exchange means 230 along the main extension axis X of the column 200, irrespective of the position of this column 200. In other words, the position of this exchange means 230 along the main extension axis X of the column 200 is ensured whether the apparatus to which this column 200 belongs is in its operational position, or in any other position, for example a transport or assembly position.

Because these two retaining devices 240 are produced in accordance with the present invention, the description of one of them, given hereinafter, can be reapplied directly to the other.

Similarly, the retaining device 240 illustrated in FIG. 1 is also identical to these two retaining devices 240 illustrated in FIG. 2, and the description of these two retaining devices 240 which will follow applies mutatis mutandis to the retaining device 240 illustrated in FIG. 1. In order not to overburden the figure, certain references are borne by only one of these retaining devices 240, but it will be appreciated that these can be applied directly to the other one.

The retaining device 240 according to the present invention comprises at least two strips 241. In order to be able to show certain features of the retaining device and of the strips of which it is composed, just one strip of the retaining device positioned under the heat and/or mass exchange means 230 in FIG. 2 has been depicted, the other retaining devices 240 depicted in FIGS. 1 and 2 being depicted with three strips at least partially visible. Chamfers 247 and the planar part of the two strips 241 that are perpendicular to the plane of the figure can be seen in the cutouts of the strip 241 in the plane of the figure. Each of these strips 241 extends in a main direction of extension D between two longitudinal ends 242. As depicted in FIGS. 1 and 2, the two longitudinal ends 242 of at least one strip 241 are joined together by two transverse edges 244 and they are arranged bearing against the peripheral wall 210 of the column 200, and more particularly against the internal face 212 of this peripheral wall 210. In other words, at least one strip 241 of the retaining device 240, and advantageously each strip 241 of this retaining device 240, has at least two zones 250 of contact with the internal face 212 of the peripheral wall 210. More specifically, the longitudinal ends 242 of at least one strip 241, and advantageously the longitudinal ends 242 of each strip 241, contribute to forming these contact zones 250.

In order to make it easier to insert the strips 241, and, therefore, the retaining device 240, in the column 200, the longitudinal ends 242 of the strips 241 each have at least one chamfer 247. Advantageously, each longitudinal end 242 has two chamfers 247 connected by a ridge 248 which extends in a direction perpendicular to the main direction of extension D of the strip 241, namely a direction parallel or substantially parallel to the internal face 212 of the peripheral wall 210 of the column 200.

In that way, each strip 241 can easily be inserted into the heat and/or mass exchange column 200, whatever the direction of this insertion. As illustrated, once the strip 241 has been inserted, the zones 250 of contact between this strip 241 and the internal face 212 of the peripheral wall 210 are formed, on the one hand, by a portion of said internal face 212 and, on the other hand, by one of the ridges 248 that connects the chamfers 247 of that strip 241.

It may also be noted that the strip 241 comprises at least two cutouts 245, distributed at the two longitudinal ends 242 of the strip 241. In other words, each cutout 245 is formed closer to one of the longitudinal ends 242 than to a center 246 of this strip 241. In other words, a first distance d1 measured between one of the cutouts 245 concerned and the longitudinal end 242 of the strip 241 that is closest to this cutout 245 is less than a second distance d2 measured between the cutout and the center 246 of the strip 241, namely a point equidistant from the two longitudinal ends 242 of the strip 241, this first distance d1 and this second distance d2 being measured parallel to the main direction of extension D of the strip 241. These cutouts 245 confer elasticity on the strip 241, allowing it to deform. In other words, these cutouts 245 are configured to allow an adjustment of a dimension of elongation of the strip 241, in the main direction of extension D of this strip.

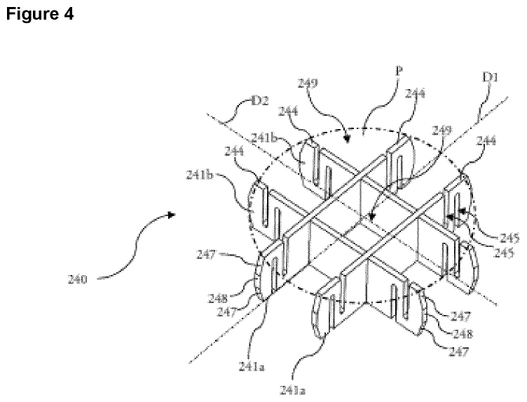

As depicted, each cutout 245 extends perpendicular to the main direction of extension D of the strip 241, from one of the transverse edges 244 of this strip 241. According to the example illustrated in FIGS. 1 and 2, the two cutouts 245 of the one same strip 241 extend from the same transverse edge 244 of the strip 241. Alternatively, each cutout 245 may be formed from an opposite transverse edge 244 to the transverse edge 244 from which the other cutout 245 is formed. In other words, according to this alternative, the two cutouts 245 are arranged top to tail. As will be detailed more fully hereinafter with reference to FIGS. 3 and 4, each strip 241 may comprise at least four cutouts.

At least one strip 241, advantageously all the strips 241 of the retaining device 240, has a longitudinal dimension, namely one measured between its two longitudinal ends 242 parallel to its main direction of extension 0, that is greater than a cross section of the column 200 in which it is arranged, this cross section of the column 200 being measured between two opposing points on the internal face 212 of the peripheral wall 210 thereof, parallel to a direction perpendicular to the main extension axis X of the column 200. The result of this is that, by virtue of the cutouts 245 formed in this strip 241, the latter deforms when it is introduced into the column 200. More particularly, the longitudinal dimension of the strip 241 is reduced as it is inserted into the column 200.

Once inside the column 200, this strip 241 tends to revert to its original longitudinal dimension, thus applying a force F against the internal face 212 of the peripheral wall 210, and more specifically in the zone 250 of contact formed between the internal face 212 of the peripheral wall 210 and the longitudinal ends 242 of the strip 241.

Thus, each strip 241 of which the longitudinal ends 242 are bearing against the internal face 212 of the peripheral wall 210 generate two forces F that are parallel and in opposite directions which ensure mechanical retention of the strip 241 concerned, and therefore of the retaining device 240 that comprises this strip 241, It will therefore be appreciated that it is these forces F that provide the mechanical retention of the retaining device 240 in the internal volume 201 of the column 200. It will therefore be appreciated that the strips 241 illustrated in FIGS. 1 and 2 in position in the column 200 are deformed, in the sense of a reduction in their longitudinal dimension. This reduction in their longitudinal dimension is, however, imperceivable to the naked eye,

According to the example illustrated here, the strip 241 comprises two slots 243. As was specified previously, in FIG. 2, two of the strips 241 of the retaining device 240 arranged under the exchange means 230 have not been depicted, in order to render these slots 243 visible. Advantageously, all the slots 243 are identical and the description of one of them, which will follow, applies mutatis mutandis to the others.

These slots 243 are configured to accept another strip 241 that makes up the retaining device 240 in question. Each of these slots 243 extends from one transverse edge 244 of the strip 241 concerned and extends in a direction perpendicular to the main direction of extension D of said strip 241 and as far as substantially halfway along the height of the strip 241 which is to say the dimension of the strip between the two transverse edges. Thus, each slot 243 has an open end which opens onto one of the transverse edges 244 of the strip 241 and which allows the insertion of another strip 241, and each slot 243 also has a closed end which acts as an end stop for the insertion of this other strip 241, midway along the height of this strip 241.

It may also be noted that, according to the example illustrated here, each slot 243 extends from the transverse edge 244 from which the cutouts 245 formed as close as possible to the longitudinal ends 242 of said strip 241 also extend.

It must be appreciated that this is merely one embodiment of the present invention and that the strip 241 could comprise a single slot 243, in the case of a retaining device 240 comprising just two strips 241 as for example illustrated in FIG. 3. Alternatively, the strip 241 could comprise more than two slots 243, there being no maximum number of slots 243 defined. According to the example illustrated in FIG. 2, these slots 243 artificially divide the strip 241 into three portions of equivalent lengths, these lengths being measured parallel to the main direction of extension D of the strip 241.

As previously mentioned, the retaining device 240 according to the invention acts as a support for the heat and/or mass exchange means 230, which is to say that this heat and/or mass exchange means 230 bears against this retaining device 240. More specifically, one transverse edge 244 of at least two strips 241 of the retaining device 240, advantageously one transverse edge 244 of each strip 241 of the retaining device 240, extends in a plane P against which the exchange means 230 bears. According to the invention, this plane P forms a planar bearing surface for the heat and/or mass exchange means 230. Optionally, a mesh structure 260 may be arranged between the exchange means 230 and the retaining device(s) 240. This mesh structure 260 notably reduces the risks of the exchange means 230, or part of this exchange means 230, passing through the retaining device 240. In other words, this retaining device 240 has openings - which will be described more fully hereinafter with reference to FIGS. 3 and 4—of which a cross section is greater than a cross section of the mesh cells of the mesh structure 260. According to the example illustrated here, two mesh structures 260 are arranged in the internal volume 201 of the column 200, respectively between the heat and/or mass exchange means 230 and one of the two retaining devices 240 arranged in this column 200. It will be appreciated that this is merely one embodiment and that provision could be made for the column 200 to comprise just one mesh structure 260 or else for it to be completely devoid of such a structure.

According to the invention, the mesh structure 260 and/or the strips 241 of the retaining device 240 comprise mass of which the melting point is higher than the maximum operating or manufacturing temperature of the column.

Thus, at least the mesh structure 260 and/or the strips 241 of the retaining device 240 are made for example of stainless steel, which has a melting point higher than 1000° C.

Advantageously, that makes it possible to avoid any deformation or deterioration of the mesh structure 260 and/or of the retaining device 240 during the course of operating and/or manufacturing the heat and/or mass exchange column for which they are intended.

The heat exchange means 230 may also be made of stainless steel. In any event, this heat exchange means 230 will be made from mass of which the melting point is higher than 500° C., for the reasons mentioned hereinabove. This heat exchange means 230 may for example comprise random packings, such as beads and/or spirals and/or rings, and/or structured packings, for example, corrugated or flat sheets extending predominantly in a direction parallel to the main extension axis X of the column. Whatever it might be, the exchange means 230 enables an increase in an area of contact, and therefore of heat and/or mass exchange, between the first fluid and the second fluid which are circulating in the column 200.

The retaining device 240 according to the invention will now be described in greater detail with reference to FIGS. 3 and 4. FIG. 3 is a view, in perspective, of the retaining device 240 according to a first embodiment of the present invention, and FIG. 4 is a view, in perspective, of the retaining device 240 according to a second embodiment of the present invention. The features that are common to the first and second embodiments will be described first of all before the features specific to each embodiment are then described more fully. As previously mentioned, the strips 241 of a retaining device 240 according to the invention are identical, which means that the references borne by one of them can be reapplied directly to the others.

As previously mentioned, the retaining device 240 according to the invention comprises at least two strips 241 which have at least the features described hereinabove, with reference to FIG. 2. As illustrated, these strips 241 intersect, thus generating at least four openings 249 between the peripheral wall of the column across which the retaining device 240 is intended to be positioned, and the regions of contact that the longitudinal ends 242 of these strips 241, and more particularly the ridges 248 of these longitudinal ends 242, contribute to forming.

According to the embodiments illustrated in FIGS. 3 and 4, each strip 241 comprises at least four cutouts 245 distributed in pairs near each longitudinal end 242 of the strip 241 concerned. As previously mentioned, what is meant by “near” is that these cutouts 245 are formed closer to the corresponding longitudinal end 242 of the strip 241 than to the center of that strip 241. According to the invention, the two cutouts 245 of the one same pair of cutouts 245 are formed from two opposite transverse edges 244 of the strip 241 concerned. In other words, the two cutouts 245 of the one same pair of cutouts 245 are formed top to tail. It will also be noted that, for a one same strip 241, the two cutouts 245 formed closest to each longitudinal end 242 are formed from the same transverse edge 244 the strip 241. Furthermore, the cutouts 245 of two strips 241 fitted one in the other by virtue of the slots 243 are formed as mirror images. In other words, between two strips 241 that collaborate via their slots 243 a reversal of the cutouts 245 with respect to the transverse edges 244 from which they extend can be observed.

Advantageously, it will be appreciated that the top to tail arrangement of the cutouts 245 ensures that the strip 241 deforms in the desired direction when inserted into the column, namely that this strip 241 deforms in the direction of a reduction in its length. In other words, this then ensures that the strip 241 deforms in a direction that brings its longitudinal ends 242 closer together. In addition, the manufacture of the strips 241 can thus be standardized, which means that the costs of manufacturing a retaining device 240 according to the invention are lower.

As mentioned hereinabove, one transverse edge 244 of at least two strips 241, advantageously one transverse edge 244 of each strip 241 contributes to defining the plane P against which the heat and/or mass exchange means 230 bears, which is to say that at least two strips 241 have a transverse edge 244 contributing to forming the bearing surface of the exchange means 230. It will be appreciated that, in the event that the mesh structure 260 is interposed between the exchange means 230 and the retaining device 240, it is this mesh structure 260 that rests against this bearing surface, the exchange means 230 for its part resting against this mesh structure 260.

According to the first embodiment illustrated in FIG. 3, the retaining device 240 according to the invention comprises two strips 241 which intersect substantially at their centers. In other words, each of these two strips 241 comprises a slot formed from one of its transverse edges 244 as described hereinabove, and extending toward the other transverse edge 244, passing via the center of this strip 241. As depicted, the retaining device 240 according to this first embodiment of the present invention adopts the shape of an X, and more specifically a cross shape. It will be appreciated that four openings 249 are thus generated between these strips 241 and the internal face 212 of the peripheral wall 210 of the column 200.

According to the second embodiment illustrated in FIG. 4, the retaining device 240 according to the invention comprises four strips 241 which are arranged as a lattice. More specifically, these four strips 241 are, according to this second embodiment, parallel in pairs. In other words, the main extension directions of these strips are mutually parallel, in pairs. Thus, two of these strips 241 extend mainly in a first direction D1, the other two strips 241 extend in a second direction D2, the first direction D1 being perpendicular to the second direction D2. As illustrated in FIG. 3, the main extension directions of two first strips 241a are parallel to the first direction D1, and the main extension directions of two second strips 241b are, for their part, parallel to the second direction D2. The result of this is that, in addition to the eight openings 249 created between the strips 241 and the internal face of the peripheral wall of the column for which the retaining device 240 in question is intended, a ninth opening 249 is generated between these four strips 241, According to the second example illustrated here, this ninth opening 249 is square, which is to say that the strips 241 form a square grid pattern.

It must be appreciated that these are merely two exemplary embodiments of the present invention and that the retaining device 240 according to the present invention could comprise more strips 241 than have just been described. For example, on the basis of the second embodiment, it would be possible to anticipate a third embodiment, not illustrated here, in which three strips extend in the first direction, three slots then being formed in each of the strips which extend parallel to the second direction, each of these slots being intended to accept one of the strips that extend in the first direction. In other words, thy dimensions of the retaining device can easily be adapted to suit different columns, namely columns the dimensions of which vary, and more particularly, columns with different cross sections. However, the preference will be for square or circular columns in which the strips that make up the retaining device according to the invention are all identical, so that the manufacture thereof can be standardized, thus allowing a reduction in these production costs.

The present invention thus proposes a means that is simple, inexpensive and requires no assembly operation for maintaining the vertical position of a heat and/or mass exchange means in a heat and/or mass exchange column, which is to say for maintaining the position of this exchange means along a main extension axis of this column, regardless of the position of this column,

The present invention is not, however, limited to the means and configurations described and illustrated here, and it also extends to any equivalent means and configuration and to any technically effective combination of such means. In particular, the shape and the arrangement of the strips that make up the retaining device according to the invention can be modified without being detrimental to the invention, as long as they meet the functionalities described and illustrated in the present document.

1.-20. (canceled)

21. A heat and/or mass exchange column comprising at least one peripheral wall delimiting an internal volume in which there are arranged at least one heat exchange means and at least one retaining device for retaining the heat and/or mass exchange means, the device comprising at least one flexible strip in which there are formed at least two cutouts, the strip extending predominantly in a main direction of extension between two longitudinal ends, the cutouts being configured to adjust a dimension of elongation of the strip, in said main direction of extension, to suit a dimension of the heat and/or mass exchange column, wherein at least the longitudinal ends of the at least one strip bear against the peripheral wall.

22. The column as claimed in claim 21, wherein the two longitudinal ends are joined together by two transverse edges and wherein the cutouts are respectively formed closer to one of the longitudinal ends of the strip than to a center of this strip.

23. The column as claimed in claim 22, wherein each cutout extends from one of the transverse edges of the strip.

24. The column as claimed claim 22, wherein the strip comprises at least four cutouts, distributed in pairs, each pair of cutouts being formed closer to one longitudinal end of the strip than to the center of this strip.

25. The column as claimed in claim 24, wherein the two cutouts of a pair of cutouts respectively extend from opposite transverse edges of the strip.

26. The column as claimed in claim 22, wherein at least one longitudinal end of the strip has at least one chamfer.

27. The column as claimed in claim 21, wherein the device comprises at least two strips.

28. The column as claimed claim 27, wherein the strips intersect.

29. The column as claimed in claim 21, wherein the device comprises at least four strips forming a lattice.

30. The column as claimed in claim 29, wherein the strips are parallel in pairs.

31. The column as claimed in claim 21, wherein at least one strip comprises at least one slot configured to accept another strip.

32. The column as claimed in claim 21, wherein the strips comprise a mass with a melting point higher than 500° C.

33. A heat and/or mass exchange column as claimed in claim 21, wherein at least two strips of the retaining device have a transverse edge that can be inscribed in a plane against which the heat and/or mass exchange means rests.

34. The heat and/or mass exchange column as claimed in claim 21, extending predominantly along a main extension axis, the heat and/or mass exchange column comprising at least two retaining devices arranged one on each side of the at least one heat and/or mass exchange means along the main extension axis.

35. The heat and/or mass exchange column as claimed in claim 21, comprising at least one mesh structure arranged between the heat and/or mass exchange means and at least one retaining device.

36. The heat and/or mass exchange column as claimed in claim 21, wherein the at least one heat and/or mass exchange means comprises beads and/or plates extending predominantly in a direction parallel to a main extension axis of the column and/or structured packings and/or random packings.

37. A heat and/or mass exchange apparatus comprising at least one heat and/or mass exchange column as claimed in clam 21.

38. The heat and/or mass exchange apparatus as claimed in claim 37, comprising at least one liquid inlet and at least one gas inlet which are distributed on either side of the heat and/or mass exchange means arranged in the column, along a main extension axis of this heat and/or mass exchange column.

39. A heat and/or mass exchange process using a heat and/or mass exchange apparatus as claimed in claim 38, wherein the process is a scrubbing and/or cooling and/or heating and/or distillation and/or treatment process.
